(19) United States
(12) Patent Application Publication
(10) Pub. No.: US 2009/0282939 A1
(43) Pub. Date: Nov. 19, 2009

(54) SPIRAL-TOOTHED GEAR

(75) Inventors: Waldemar Rogowski, Lotte/Wersen (DE); Remt Blankenspeck, Drebber (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSHAFEN AG, Friedrichshafen (DE)

(21) Appl. No.: 12/306,298

(22) PCT Filed: Jun. 12, 2007
(86) PCT No.: PCT/DE2007/001042

§ 371 Date: Dec. 23, 2008

(30) Foreign Application Priority Data
Jun. 28, 2006 (DE) 10 2006 030 097.1

(51) Int. Cl. F16H 55/17

(52) U.S. Cl. 74/424.5

(57) ABSTRACT

A spiral-toothed gear is provided with a toothed ring (2) formed by extrusion coating a basic body (1) with a plastic. The spiral-toothed gear provides a connection between the basic body (1) and the toothed ring (2), whose strength makes possible the transmission of high torques in a reliable manner. The basic body (1) of the spiral-toothed gear has a flange with a disk-shaped area (1′) that is extrusion coated with the plastic toothed ring (2). The area (1″) of reduced diameter adjoining area (1′) forms a hub for mounting the spiral-toothed gear on a shaft in such a way that it rotates in unison. The area (1′) of the flange has, axially on both sides, a plurality of recesses (3, 3′) each, which are arranged distributed on its circumference, extend primarily in the axial direction but do not pass through area (1′). The recesses (3, 3′) are of a dovetail design, so that sections (4, 4′) of the outer circumference of area (1′), which are left in place between them, are undercut by the edges of the recesses (3, 3′), which said edges extend in the axial direction.

### CROSS REFERENCE TO RELATED APPLICATIONS

This application is a United States National Phase application of International Application PCT/DE2007/001042 and claims the benefit of priority under 35 U.S.C. § 119 of German Patent Application DE 10 2006 030 097.1 filed Jun. 28, 2006, the entire contents of which are incorporated herein by reference.

### FIELD OF THE INVENTION

The present invention pertains to a spiral-toothed gear, which is to be arranged as part of a transmission, rotating in unison on a shaft or the like. It pertains, in particular, to a spiral-toothed gear, the running surface of which, shaped in the form of a toothed ring, is formed by extrusion coating a basic body with a plastic.

### BACKGROUND OF THE INVENTION

Even though gears and spiral-toothed gears made of metal have, in general, a higher mechanical strength than gears consisting of plastic, they often cause rather substantial running noises during their use in a transmission. It is therefore known that spiral-toothed gears are designed, to a certain extent, in a hybrid form by their basic body being made of a mechanically stable and wear-resistant material, such as metal, and this basic body is surrounded, to form the running surface, with a material that possesses good sliding properties. It is achieved as a result that such spiral-toothed gears have the mechanical stability necessary for their use as intended, on the one hand, but have, on the other hand, a very quiet running.

A corresponding spiral-toothed gear is known, for example, from EP 1 339 596 B1. A gear, which is designed as a worm gear because of its teeth and which is also called a built-up gear, is described in the document. The corresponding worm gear has a plastic toothed ring, which is mechanically stabilized in its radially middle area by metallic flanges arranged axially on both sides. The individual segments of the worm gear, i.e., the toothed ring consisting of plastic and the metallic flanges, are firmly connected to one another by projections, which are formed on the flanges, extend in the axial direction through the plastic toothed ring and mesh with corresponding recesses of the respective other flange and by means of screws led axially through the arrangement. However, this design leads to a comparatively great assembly effort in the manufacture of the spiral-toothed gear. In addition, the effort needed for manufacturing is higher due to the fact that the individual components of the spiral-toothed gear may have only comparatively small tolerances in order to be able to be reliably connected to one another.

A reduction of the manufacturing effort and hence of the manufacturing costs can be achieved by the outer plastic toothed ring manufactured separately by an injection molding process in the solution explained above being manufactured by direct extrusion coating of a mechanically stable basic body, consisting, for example, of aluminum, with the plastic. However, measures must be taken in this case to guarantee a reliable connection between the basic body and the toothed ring, which connection also makes possible the transmission of higher torques.

### SUMMARY OF THE INVENTION

An object of the present invention is to provide a spiral-toothed gear, which can be embodied by extrusion coating a mechanically stable basic body with a plastic, and which meets these requirements. In particular, a connection, whose strength also reliably permits the transmission of high torques during the use of the spiral-toothed gear as intended, shall be achieved especially between the basic body and the outer toothed ring consisting of plastic by a corresponding design of the spiral-toothed gear. The components of the spiral-toothed gear shall, moreover, preferably be designed such that no or only little finishing is necessary to eliminate projections or for smoothing joint lines after the extrusion coating of the basic body with the toothed ring.

The spiral-toothed gear proposed to accomplish the object comprises a basic body, which is designed as a flange and whose disk-shaped area is extrusion coated with a plastic to form a toothed ring. The area with reduced diameter, which is formed at the disk-shaped area corresponding to the typical flange shape, forms a hub for mounting the spiral-toothed gear in such a way that it rotates in unison on a shaft. According to the present invention, the disk-shaped area of the flange has axially on both sides a plurality of recesses each, which are arranged distributed on its circumference, extend primarily in the axial direction but do not pass through the disk-shaped area. The recesses are of a dovetail shape, so that the sections of the outer circumference of the disk-shaped area, which are left in place between the recesses, are undercut by the edges of the recesses, which said edges extend in the axial direction. When the flange is extrusion coated, the plastic flows into the recesses and under the edges, which undercut the sections left in place between the recesses. As a result, the plastic, which forms the toothed ring because of a correspondingly shaped injection mold, forms a rigid, positive-locking connection with the flange during curing or solidification. Due to the plurality and special shape of the flat recesses, which extend primarily in the axial direction, i.e., are flat in respect to their radial extension, the strength of the connection between the flange and the toothed ring reaches a value that also makes it possible to transmit higher torques during the use of the toothed ring as intended. Due to the direct extrusion coating of the flange to prepare the toothed ring, the shape and position tolerances between the flange and the toothed ring are advantageously significantly limited. The recess and its special shape now ensure firm seating of the toothed ring axially, radially and in the circumferential direction of the spiral-toothed gear.

The recesses extending from both axial sides of the disk-shaped area into this area are preferably arranged such that the recesses originating from one axial outer side of the disk-shaped area are arranged offset in relation to those of the respective other axial outer side. In view of the most uniform distribution possible of the plastic on the outer circumference of the disk-shaped area and balanced material conditions relative to the geometry and the weight distribution, the recesses alternatingly extend into the disk-shaped area from one and the other axial outer side of the disk-shaped area. The recesses are, moreover, advantageously designed such that they expand towards the axial outer sides of the disk-shaped area in respect to their extension to the circumference. As was mentioned above, firm seating of the plastic toothed ring on the flange is achieved due to the design of the recesses, and there is at the same time advantageously a possibility of axial expansion during thermal loads.

According to an especially preferred variant of the spiral-toothed gear according to the present invention, the flange of the spiral-toothed gear is designed such that this flange is injected from the side for extrusion coating with the plastic. Corresponding to this variant, the axial outer surface of the disk-shaped area facing the hub has a circumferential, ring-shaped sprue channel under the recesses. Distributed over the circumference, a plurality of beads acting as injection points for the injection molding process are arranged in this sprue channel. To extrusion coat the flange, the plastic can thus be injected into a correspondingly shaped injection mold from this side, directed towards the beads. An especially uniform pressure distribution of the injected plastic mass within the sprue channel is achieved due to the beads. The cavity of the injection mold is filled through the sprue channel itself, as a result of which blind seams are advantageously greatly minimized. The finishing needed on the spiral-toothed gear removed from the injection mold is significantly reduced as a result.

When the plastic is injected, it first fills the beads and, after flowing over them, the sprue channel. The plastic flowing herefrom radially outwardly because of the corresponding shape of the injection mold finally surrounds the disk-shaped area of the flange, forming the toothed ring, and the flow paths that are possible depending on the further shaping of the flange shall be shown below and in the explanation of the exemplary embodiments.

The embodiment of the spiral-toothed gear according to the present invention provided with the lateral sprue channel is varied, among other things, by axially extending holes being prepared in the sprue channel on one side or on both sides, adjacent to the beads. In one possible embodiment, these holes pass through the disk-shaped area in the axial direction.

Especially in view of another embodiment, provided in view of creating suitable flow paths for the plastic, the recesses, which are present on the outer circumference of the disk-shaped area according to the basic solution according to the present invention, extend from their axial outer sides in the axial direction into this area only to such an extent that a contiguous, ring-shaped web extending circumferentially on the outer circumference of the disk-shaped area is left between them. This web is preferably arranged axially centrally within the disk-shaped area. In the other embodiment already mentioned, a slot or groove, which extends into the disk-shaped area, extending in the radial direction circumferentially on the outer circumference, is formed here in this web. More precisely, this groove extends in the axial direction into the disk-shaped area up to the level of the holes prepared in the sprue channel adjacent to the beads. The holes are in turn led in the axial direction up to the groove or slot mentioned above. As a result, the following flow path is obtained for the plastic during the extrusion coating operation. The beads are first filled with the plastic. After the plastic overflows them, the plastic flows via the sprue channel and the holes into the slot or groove extending radially into the disk-shaped area and rises radially outwardly in the groove. The plastic, which continues to flow in, finally flows around the radially outer area of the flange to form the toothed ring.

The flange of the spiral-toothed gear according to the present invention may consist of various materials. However, it preferably consists of metal, for example, aluminum. However, manufacturing from glass fiber-reinforced plastic may be considered as well. A polyamide is preferably used to make the toothed ring.

Details of the present invention shall be illustrated below once again on the basis of exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top view from the radial direction showing the not yet extrusion-coated flange of a first embodiment of the spiral-toothed gear according to the present invention;

FIG. 2 is a top view from the axial direction showing the flange according to FIG. 1;

FIG. 3 is an axially cut-away view showing the flange according to FIG. 1;

FIG. 4 is an axially cut-away view showing the flange according to FIG. 3 after extrusion coating with plastic;

FIG. 5 is a cut away perspective view showing another embodiment of the spiral-toothed gear according to the present invention with the extrusion-coated flange partially cut away; and

FIG. 6 is a sectional view of the flange of the embodiment according to FIG. 5 during the extrusion coating with plastic shown in the mold suitable therefor.

### DESCRIPTION OF THE PREFERRED EMBODIMENTS

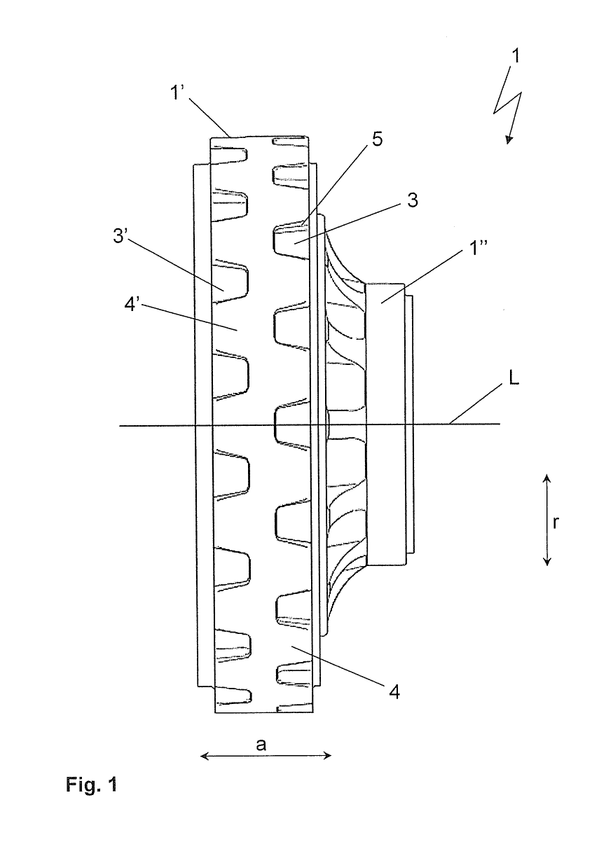

Referring to the drawings in particular, FIG. 1 shows the basic body 1 of a first embodiment of the spiral-toothed gear according to the present invention, which is not yet extrusion coated with plastic, in a top view from the radial direction r. As can be recognized, the basic body 1 is designed in the form of a flange. By extrusion coating flange 1, a circumferential plastic toothed ring 2 is later formed on the radial front surface of its disk-shaped area 1′. An area 1″ of reduced diameter, which forms the hub 1″ of the later spiral-toothed gear intended for being mounted on a shaft or the like in such way that it rotates in unison, is made integrally in one piece with the disk-shaped area 1′. As was stated above, flange 1 preferably consists of aluminum, but it may also be made of a glass fiber-reinforced plastic.

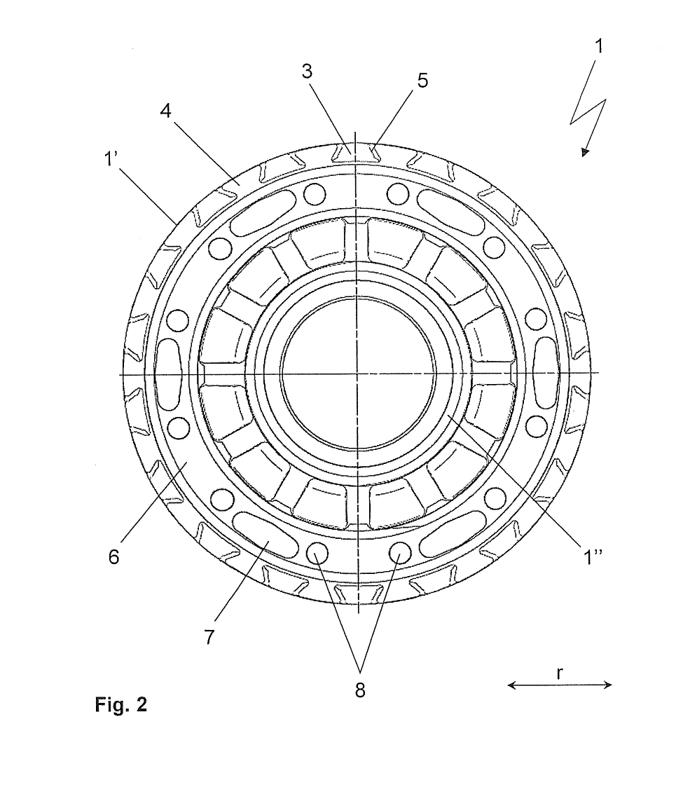

According to the basic idea of the present invention, a plurality of dovetail-shaped recesses 3, 3′, which are arranged distributed over the outer circumference of the disk-shaped area 1′, are formed axially on both sides of the disk-shaped area 1′. As is apparent from the figure, the recesses 3, 3′ extending from the outer edge of both axial sides in the direction of the axial center of area 1′ are arranged offset in relation to one another. They extend in the axial direction a without passing through area 1′ and without uniting with a recess 3, 3′ on the axially opposite side. More precisely, the recesses 3, 3′ extend alternatingly from one side and the axial side of the disk-shaped area 1′ such that they do not quite reach the axial center of the area, so that a contiguous web 9 extending in a ring-shaped shape on the circumference is formed between the recesses 3, 3′. The recesses 3, 3′ extend primarily in the axial direction a, i.e., they are maintained flat, so that their axial extension is preferably greater than their extension in the radial direction. This is shown once again in FIG. 2, which shows flange 1 according to FIG. 1 in a top view from the axial direction a. Sections 4, 4′ of the outer circumference of area 1′, which are left in place between the recesses 3, 3′, are undercut by the edges 5 of the dovetail-shaped recesses 3, 3′, which the edges extend in the axial direction a. An especially firm connection is achieved as a result between the plastic toothed ring 2 surrounding the flange 1 after the extrusion coating and flange 1. The plastic forming the running surface and the toothed ring 2 flows into the recesses 3, 3′ and especially under the edges 5 undercutting sections 4, 4′ during the injection operation, so that a connection, which has a high load-bearing capacity also in respect to high torques acting on the spiral-toothed gear, is obtained between flange 1 and toothed ring 2.

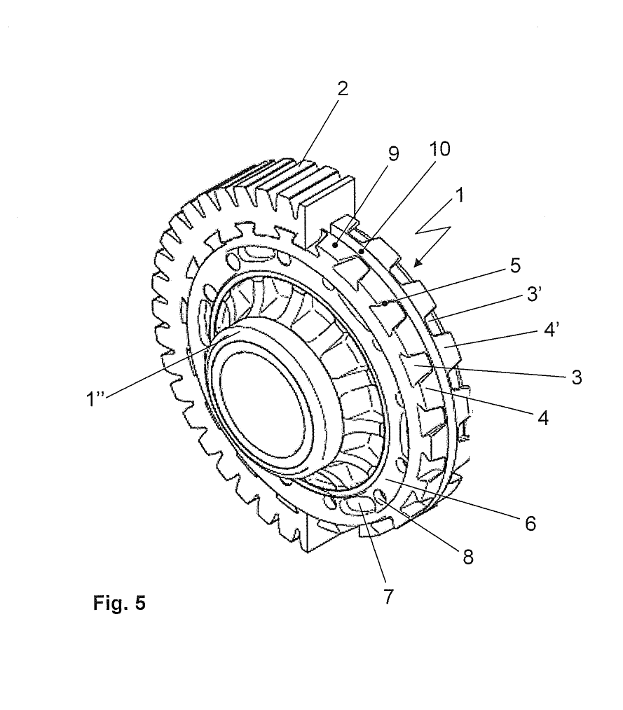

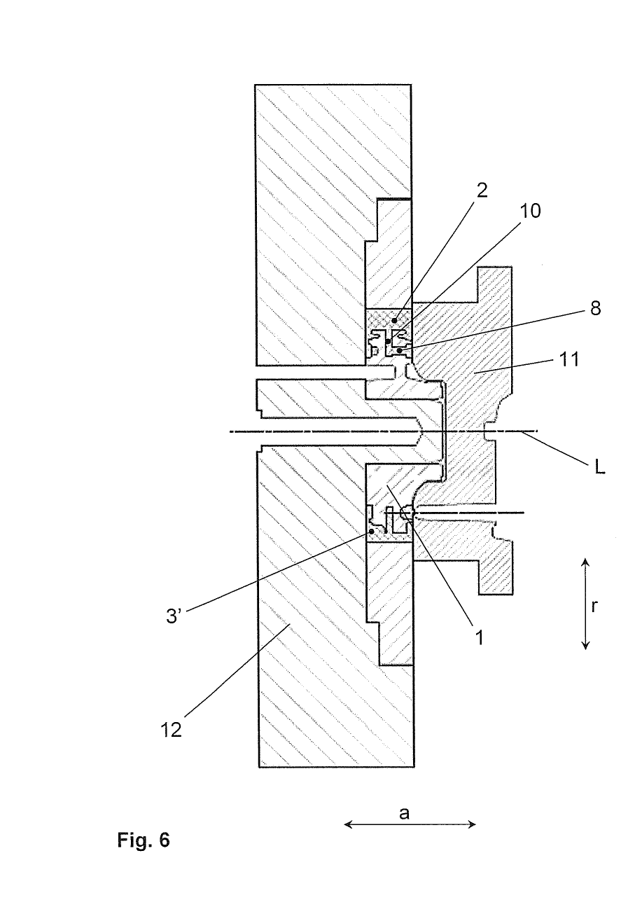

To keep low the amount of finishing necessary for removing projections and for smoothing joint lines after the injection molding operation, flange 1 has a special design, besides the recesses 3, 3′ as well as the special shape and arrangement thereof. Among other things, the disk-shaped area 1′ is profiled correspondingly for an injection operation taking place from the side on its side facing area 1″ of reduced diameter, i.e., the hub 1″. A so-called sprue channel 6 is formed for this on this side in a radially inner section of the lateral surface located below the recesses 3, 3′. A plurality of beads 7 (for example, six), are formed in sprue channel 6 distributed over the circumference. These beads 7 form injection points, which are brought into contact for the injection operation with corresponding channels formed for this in the sprue plate of an injection mold for introducing the plastic. Uniform pressure distribution of the injected plastic is achieved through the beads 7. The plastic first fills the injection points or beads 7 during the injection operation and then the sprue channel 6 after overflowing the beads 7. Due to a corresponding design of the sprue plate 11, due to which there is a distance between the axial outer surface of flange 1 and the sprue plate 11 in the radially outer area of flange 1, the plastic finally flows in the radial direction r to the outside. Corresponding to the shape of the contour plate 12 (see FIG. 6, in connection with the modified embodiment according to FIG. 5), which is designed to produce a toothed ring 2, the radially outwardly flowing plastic finally flows around the radially outer areas of flange 1, and it also flows into the recesses 3, 3′. In addition, holes 8, which pass through the flange 1 and by which the flow of the plastic around the radially outer areas of flange 1 is supported, and which connect plastic areas located axially opposite each other to one another, are provided on the left and right next to each bead 7 in the example being shown.

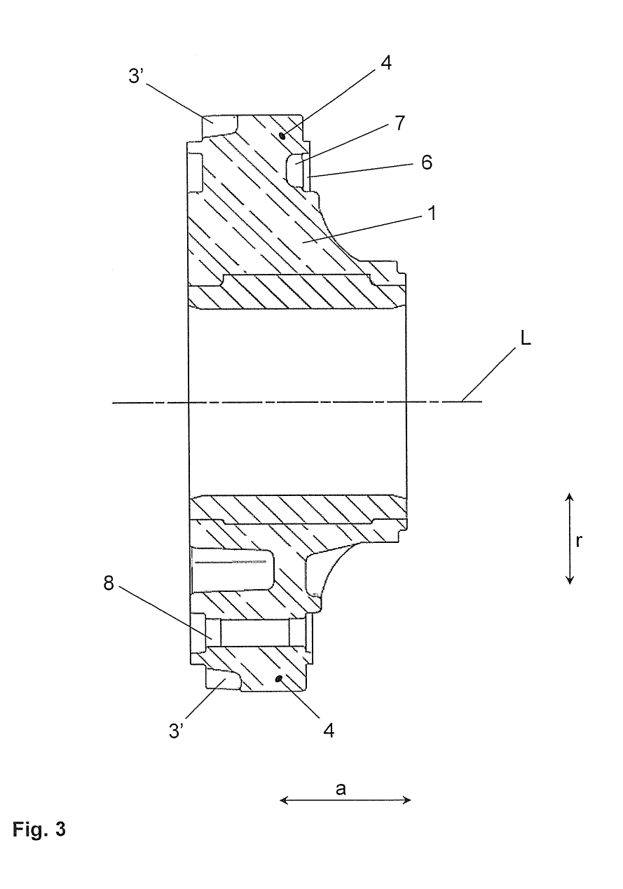

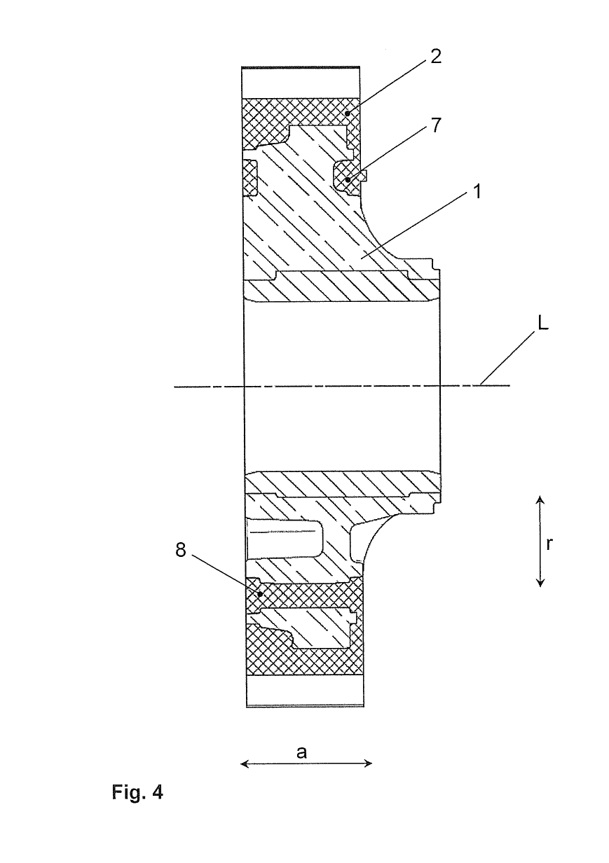

FIG. 3 shows flange 1 according to FIGS. 1 and 2 once again in a cut-away view, with a section extending radially through a recess 3 as well as a bead 7 to the central axis or longitudinal axis L and, angulated herefrom, farther through one of the holes 8 arranged next to the beads 7. As was already described, the beads 7 act as injection points, from which the plastic flows radially to the outside after overflowing the beads 7, but also through the holes 8, so that due to the correspondingly shaped contour plate 12 of the injection mold, it flows uniformly and on all sides around the radial front surface of flange 1, forming the toothed ring 2. This is once again illustrated in FIG. 4, which shows flange 1 according to FIG. 3 after the end of the injection molding operation.

FIG. 5 shows another embodiment of the spiral-toothed gear according to the present invention with an extrusion coated flange 1 in a three-dimensional view, where the outer plastic toothed ring 2 was partially removed or shown as a breakaway view so as to illustrate the present invention. In this embodiment, which is slightly modified compared to the one explained above, flange 1 has a circumferential slot approximately in the axial center of its disk-shaped area 1′, i.e., within web 9, or a sprue groove 10 extending radially into the inside of flange 1.

The correspondingly designed flange 1 is shown once again in a sectional view in FIG. 6 during the extrusion coating with the plastic. For extrusion coating with the plastic, flange 1 is received here by an injection mold comprising a contour plate 12 and a sprue plate 11. It can be clearly recognized that the holes 8 arranged to the left and right of the beads 7 shown in FIG. 5 are led up to the sprue groove 10 extending radially into the disk-shaped area 1′ of flange 1. The plastic fed via channels in the sprue plate 11 and a so-called sprue spider flows via these holes 8 into the sprue groove 10 and rises in this in the radial direction, so that, enclosing the front surface of the disk-shaped area 1′, corresponding to the shape of contour plate 12, it finally forms a toothed ring 2 on the radial outer surface of area 1′. The beads 7 already mentioned are arranged in a sprue channel 6 extending circumferentially on the axial outer side of the disk-shaped area 1′, which said outer side faces the hub 1″, in this embodiment as well. This means that the beads 7, which act as injection points, are filled first during this injection operation, and they finally overflow, and the plastic flows via the sprue channel 6 into the adjacent holes 8 and, via these, finally into the sprue groove 10 extending radially into the disk-shaped area 1′. The cavity of the mold is filled in an advantageous manner through the sprue channel 6 mentioned already several times and the beads 7, as a result of which the blind seams are greatly reduced, so that hardly any finishing is necessary in the area of the plastic enveloping the flange 1 after removal from the mold.

While specific embodiments of the invention have been shown and described in detail to illustrate the application of the principles of the invention, it will be understood that the invention may be embodied otherwise without departing from such principles.

1. A spiral-toothed gear, comprising:
a basic body comprising a flange, with a disk-shaped area on a radial outer surface and with an area of reduced diameter;
a running surface in the form of a circumferential toothed ring arranged on said disk-shaped area and with said area of reduced diameter, by which a hub is formed for mounting the spiral-toothed gear on a shaft for rotation in unison therewith, said toothed ring being made integrally in one piece in the axial direction of the spiral-toothed gear, wherein the toothed ring is formed by extrusion coating the flange with a plastic, the disk-shaped area of the flange having, axially on both sides, a plurality of dovetail-shaped recesses, which are arranged distributed on said outer surface, extend primarily in the axial direction, but do not pass axially through the disk-shaped area, and by the edges of which, which extend in the axial direction, the sections of the outer circumference, which are left in place between the recesses, are undercut, so that plastic flows, during the extrusion coating of flange, into the recesses as well as below the edges thereof, which undercut the section, and the toothed ring formed by during the solidification of the plastic based on a correspondingly shaped injection mold forms a rigid, positive-locking connection with the flange.

2. A spiral-toothed gear in accordance with claim 1, wherein a set of the recesses extend into the disk-shaped area from one of the axial outer sides of said disk-shaped area and are arranged offset in relation to another set of the recesses that extend into the disk-shaped area starting from the other axial outer side.

3. A spiral-toothed gear in accordance with claim 2, wherein the recesses extend into said disk-shaped area alternatingly from one and the other axial outer side of said disk-shaped area.

4. A spiral-toothed gear in accordance with claim 1, wherein the recesses expand, in respect to their extension on the outer surface, towards the axial outer sides of the disk-shaped area.

5. A spiral-toothed gear in accordance with claim 1, wherein a circumferential, ring-shaped sprue channel is formed radially below the recesses on the axial outer surface of the disk-shaped area, which said outer surface faces the hub, and a plurality of beads form injection points for the injection molding process, said beads being arranged in said sprue channel, distributed over the circumference, so that the plastic is injected into a correspondingly designed injection mold from this side, directed towards the beads, for extrusion coating the flange.

6. A spiral-toothed gear in accordance with claim 5, wherein holes are arranged in the sprue channel on one side or on both sides, adjacent to the beads.

7. A spiral-toothed gear in accordance with claim 6, wherein the holes pass through the disk-shaped area in the axial direction.

8. A spiral-toothed gear in accordance with claim 6, wherein starting from the two axial sides of the disk-shaped area, the recesses extend into said area in the axial direction only to the extent that a contiguous, ring-shaped web extending circumferentially on the outer circumference is left between them.

9. A spiral-toothed gear in accordance with claim 8, wherein the web is arranged axially centrally within the disk-shaped area.

10. Spiral-toothed gear in accordance with claim 8, wherein a slot or groove, which extends circumferentially on the outer circumference in the radial direction up to the level of the holes into the disk-shaped area, is formed in the web, and the holes provided in the sprue channel adjacent to the beads are led up to this slot or groove, so that the plastic first enters the beads during the injection molding operation and flows, after overflowing over the sprue channel and the holes, into the slot or groove and then radially to the outside, where the plastic flows around the front surface of the disk-shaped area, forming the toothed ring predetermined by the injection mold.

11. A spiral-toothed gear in accordance with claim 1, wherein the flange consists of metal.

12. A spiral-toothed gear in accordance with claim 11, wherein the flange consists of aluminum.

13. A spiral-toothed gear in accordance with claim 1, wherein the flange consists of a glass fiber-reinforced plastic.

14. A spiral-toothed gear in accordance with claim 1, wherein the toothed ring formed by extrusion coating the flange consists of polyamide.

15. A spiral-toothed gear, comprising:
a basic body comprising a flange portion and an integral area of reduced diameter for forming a hub for mounting the spiral-toothed gear on a shaft for rotation in unison, said flange portion having a disk-shaped area with a radial outer circumferential surface having, axially on both sides, a plurality of distributed recesses extending primarily in an axial direction but not passing axially across said disk-shaped area, said recesses having angled undercutting edges to define plastic receiving regions;
a running surface in the form of a circumferential toothed ring arranged on said disk-shaped area, said toothed ring being made integrally in one piece formed by extrusion coating the flange with a plastic, the plastic flowing under said angled undercutting into said plastic receiving regions to form a rigid positive-locking connection between said toothed ring and said flange portion.

16. A spiral-toothed gear in accordance with claim 15, wherein said recesses include a set of the recesses extending into the disk-shaped area from one axial outer side of said disk-shaped area and another set of the recesses extending into the disk-shaped area from another axial outer side of said disk-shaped area, said set of the recesses being arranged offset in relation to said another set of the recesses.

17. A spiral-toothed gear in accordance with claim 16, wherein said set of the recesses alternate in relation to said another set of the recesses.

18. A spiral-toothed gear in accordance with claim 17, wherein said angled edges of each of said recesses extend away from each other extension towards an adjacent axial outer side of the disk-shaped area.

19. A spiral-toothed gear in accordance with claim 18, wherein a circumferential, ring-shaped sprue channel is formed radially below the recesses on each axial outer surface of the disk-shaped area, which said outer surface faces the hub, and a plurality of beads form injection points for the plastic, said beads being arranged in said sprue channel, distributed over a circumference thereof, so that the plastic is injected into a correspondingly designed injection mold from this side, directed towards the beads, for extrusion coating the flange and wherein holes are arranged in the sprue channel on one side or on both sides, adjacent to the beads and wherein the holes pass through the disk-shaped area in the axial direction.

20. A spiral-toothed gear in accordance with claim 18, wherein starting from the two axial sides of the disk-shaped area, the recesses extend into said area in the axial direction only to the extent that a contiguous, ring-shaped web extending circumferentially on the outer circumference is left between them.
